(19) United States
(12) Patent Application Publication
(10) Pub. No.: US 2008/0016211 A1
(43) Pub. Date: Jan. 17, 2008

(54) Internet user-accessible database

(75) Inventors: Robin Hillary, Temecula, CA (US); Michelle McCarthy, Temecula, CA (US); Judy Johnson, San Clemente, CA (US); Kenton R. Mullins, Irvine, CA (US)

Correspondence Address: STOUT, UXA, BUYAN & MULLINS LLP, 4 VENTURE, SUITE 300, IRVINE, CA, 92618, US

(73) Assignee: LitCentral, Inc.

(21) Appl. No.: 11/827,797

(22) Filed: Jul. 12, 2007

Related U.S. Application Data
(60) Provisional application No. 60/830,559, filed on Jul. 12, 2006.

(51) Int. Cl. G06F 15/173

(52) U.S. Cl. 709/224

(57) ABSTRACT

A web application for public use and market sample groups includes a record creator for generating user demographic profiles, and allows users to critique entertainment pieces by way of Rubrics. Each Rubric relating to a given entertainment piece and presents grading elements to a user pertaining to the entertainment piece. Each element presents a choice of one or more statements to grade against. The completed Rubrics produce numeric scores that are attached to entertainment pieces along with user demographics from the profiles for quantification of the entertainment pieces' overall value based upon selectable demographic parameters.

### CROSS-REFERENCE TO RELATED APPLICATIONS

This application claims the benefit of U.S. Provisional Application No. 60/830,559, filed Jul. 12, 2006, the entire contents of which are hereby incorporated by reference.

### BACKGROUND OF THE INVENTION

1. Field of the Invention

The invention is a web-browser application with an optional desktop component, built for public use and market sample groups, that allows a User(s) to critique (assess, review) entertainment pieces and or consumer products such as plays, television/cable shows, books, music, movies, video games, sports, advertisements, products, movie trailers, commercials, equipment, and all other types of entertainment pieces or consumer products. The present invention is adapted to generate graphical and text images for providing a User interface between the public and entertainment pieces or consumer products. The web application database uses a computer system, the internet, intranet, or other network system to give Users and the general public access to the web application with results being stored in the present inventions server database.

2. Description of Related Art

Document management systems have existed for managing various types of documents. Computer systems have existed for generating and maintaining databases containing documents, pages, and other items. One popular computer-system implemented database comprises a registry system in which a number of specific merchandise items are listed for a given party, and a user can select from the list of specific merchandise items. U.S. Pat. No. 5,469,206 to Strubb et al. discloses an electronic catalog which is updated at predetermined intervals. A user of the electronic catalog can enter data to facilitate the user's viewing of only particular, predetermined portions of an electronic catalog, according to the user's instructions. Another prior-art reference, U.S. Pat. No. 4,799,156 to Shavit et al., discloses a system for interactive on-line electronic communications and processing of business transactions between a plurality of different types of independent Users.

### SUMMARY OF THE INVENTION

The present invention is adapted to view, gather, store, rank, critique, average, sort, define by demographic(s), archive and share the quantified opinions/consensuses of individuals and market sample groups regarding entertainment pieces and consumer products such as plays, television/cable shows, books, music, movies, video games, sports, advertisements, products, movie trailers, commercials, equipment and all other types of entertainment pieces and consumer products using a Rubric.

The web-browser application of the present invention is web-based with an optional desktop component and is maintained on a database server. The programming within the invention can contain Microformats, which can be defined as a set of simple, open data formats built upon existing and widely adopted standards to make the formats human readable, but structured enough for another application to use the data. Microformats are simply a better way to define web content.

The present invention is adapted to generate graphical, text and images for providing an interface between a User and a web-browser application, providing access to and from an internet, intranet or other network system.

The invention will be available in foreign language venues in an effort to collect world-wide opinions/critiques/consensuses.

The present invention can be implemented on a variety of devices such as personal computers, mobile devices, digital kiosks, cell phones, televisions, cable, satellite, and ultra-mobile devices; and can be interfaced using a mouse, keyboard, keypad, digitizer, television remote controls and touch screen.

The present invention's web-application database allows for entertainment pieces or consumer products to be critiqued (assessed, reviewed, analyzed) by registered Users to produce a numeric value (critique review score). Entertainment pieces or consumer products are critiqued using the Rubric within the web application database.

The server database of the present invention can contain a library of entertainment pieces or consumer products of upcoming, new, and or old: plays, television/cable shows, books, music pieces, movies, video games, sports, advertisements, products, movie trailers, commercials, products, etc. for Users to critique, search and view.

The present invention includes a record creator for creating a User's demographic profile. A User's demographic profile can consist of gender, age, material preference, location, likes/dislikes, religious affiliation, political affiliation, education level, User's critique status, etc. Users may be represented by avatars and or status levels.

The present invention receives revenue from advertisers, affiliates, partners, entertainment venues, etc., and or manufacturers wishing to advertise, affiliate, or use the present invention to receive consensus on a “product” via controlled focus groups. Advertisers and affiliates can target Users by a User's demographic profile.

The present invention can contain message boards, discussion forums, and chat rooms for peer-to-peer. Instant Messaging and other communication protocols may be implemented for providing communication between Users.

The critique results within the server database can be exported/imported, merged to/with, interacted with, and or RSS fed to/with other databases such as LitCentral, Moviefone, Fandango, Netflix, Movie.com, etc.

While the invention has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

Any feature or combination of features described herein are included within the scope of the present invention provided that the features included in any such combination are not mutually inconsistent as will be apparent from the context, this specification, and the knowledge of one skilled in the art. In addition, any feature or combination of features may be specifically excluded from any embodiment of the present invention. For purposes of summarizing the present invention, certain aspects, advantages and novel features of the present invention are described. Of course, it is to be understood that not necessarily all such aspects, advantages or features will be embodied in any particular implementation of the present invention. Additional advantages and aspects of the present invention are apparent in the following detailed description and claims that follow.

### BRIEF DESCRIPTION OF THE DRAWINGS

FIG. 1: User's demographic profile input area;

FIG. 2: Invention home page;

FIG. 3: Export to affiliates, partners, etc.;

FIG. 4: Expanded search for entertainment piece or consumer product by type and genre;

FIG. 5: Search for a specific entertainment piece or consumer product using a keyword;

FIG. 6: Compare the opinion a specific entertainment piece or consumer product by specified Users;

FIG. 7: Touch screen monitor on kiosk displaying Rubric

FIG. 8: Touch screen monitor on theater seats displaying Rubric;

FIG. 9: Description of a specific entertainment piece or consumer product with critiquing abilities;

FIG. 10: User's customized User home page;

FIG. 11: Rubric example and graph;

FIG. 12: Compare multiple entertainment pieces or consumer products based on a specific demographic profile, type of piece/product, genre, etc.;

FIG. 13: Comparison of multiple entertainment pieces or consumer products based on multiple demographic profiles or specified Users;

FIG. 14: Rubric (specific to a movie in the genre of comedy).

### DETAILED DESCRIPTION OF THE INVENTION

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of this disclosure, while discussing exemplary embodiments, is that the following detailed description be construed to cover all modifications, alternatives, and equivalents of the embodiments as may fall within the spirit and scope of the invention as defined by the appended claims. It is to be understood and appreciated that the process steps and structures described herein do not cover a complete process flows. The present invention may be practiced in conjunction with various techniques that are conventionally used in the art, and only so much of the commonly practiced process steps are included herein as are necessary to provide an understanding of the present invention.

It is understood that all functions performed within the web application database are stored within the present invention's server database. The web application of the present invention is web-based with an optional desktop component.

The programming of the present invention can contain Microformats, which can be defined as a set of simple, open data formats built upon existing and widely adopted standards to make the formats human readable, but structured enough for another application to use the data. Microformats are simply a better way to define web content.

The optional desktop component of the present invention can allow Users access to specific information from the database, via a personal computer, such as but not limited to receiving RSS feeds, critique results on specific entertainment pieces, notifications on entertainment pieces and consumer products, etc. For example, a User can receive an RSS feed of their favorite User's critiques, a “once-a-day” update of the critique review scores on the newest movie or book releases, etc.

The present invention is adapted to generate graphical, text, and images for providing an interface between a User and a web application, providing access to and from an internet, intranet or other network system.

The invention will be available in foreign language venues in an effort to collect world-wide opinions/critiques/consensuses.

The present invention can be implemented on a variety of devices such as personal computers, mobile devices, digital kiosks, cell phones, televisions, cable, satellite, and ultra-mobile devices; and can be interfaced using a mouse, keyboard, keypad, digitizer, television remote controls and touch screen.

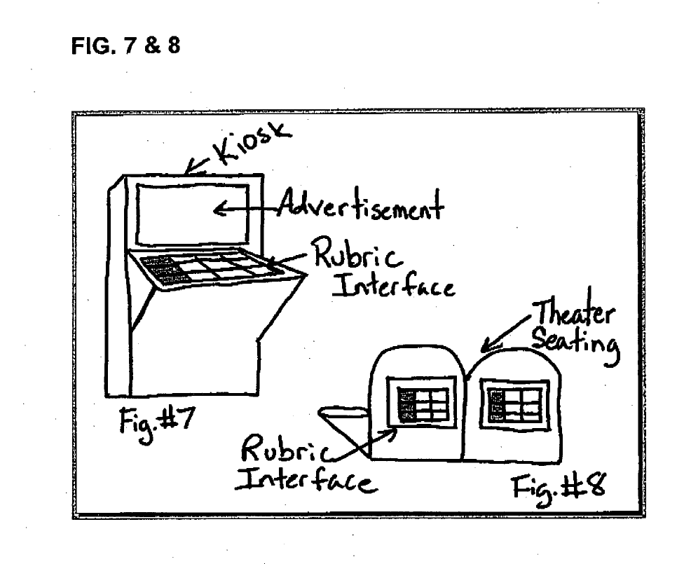

The present invention can allow for touch-screen digital kiosks equipped with the web application (more specifically the Rubric associated with the present invention) to be placed in movie theaters, so Users can immediately critique a movie (FIG. 8). Kiosks may also be placed in locations such as but not limited to video stores, book stores, etc. Users can use the kiosks to critique, search, view entertainment pieces or consumer products (FIG. 7). The kiosks can be linked via internet, intranet, or other network system.

The present invention allows for relationships with cable/dish/satellite/Fios manufacturers and media owners for the in-home critique of movies, cable shows, commercials, and televisions programs via a User's television and television remote control. For example, after a television show has been televised, a User can critique the television show (using the Rubric associated with the present invention) using their remote control. The critique results can be electronically transmitted to the web application database of the invention via the internet, intranet, or other network system, with the option to transmit the critique results directly to the manufacturer, studio, or media owner.

The invention will provide a toll-free and text phone number to Users to allow for cell phone critiquing of entertainment pieces or consumer products (similar to American Idol). The results will be forwarded electronically to the web application database via the internet, intranet, cell phone towers, or other network system.

As used herein, an entertainment piece or consumer product can be defined as a play, television/cable show, book, music piece, movie, video game, sport, advertisement, product, movie trailer, commercial, equipment or product. The server database of the present invention can contain a library of entertainment pieces or consumer products of upcoming, new, and or existing: plays, television/cable shows, books, music pieces, movies, video games, sports, advertisements, products, movie trailers, commercials, products, etc. for Users to critique, search and view.

The present invention's web application database allows for entertainment pieces or consumer products to be critiqued (assessed, reviewed, analyzed) by registered Users to produce a numeric value (critique review score). Entertainment pieces or consumer products are critiqued using the Rubric within the web application database. To calculate a numeric value a User would complete the Rubric by choosing one declarative statement to each element in the Rubric. Numeric values are based on a 100 point scale, with results ranging from 50 to 100, and are calculated by dividing the total number of elements (e.g., 5) by the value (i.e. numerical score) each element receives (e.g. 10-20), by the User critiquing the entertainment piece or consumer product.

As used herein, the term “User” can also be referred to as Member and is defined as one who has registered for the present invention's web application. Users can critique (assess, review, analyze) an entertainment piece and or consumer product to give an opinion, and to create a numeric value (critique review score) for the entertainment piece/consumer product. Users can view critique results of entertainment pieces or consumer products created by other Users. Users can search critique results of entertainment pieces or consumer products by a specific demographic (or multiple demographics). Users can access message boards and forums to discuss entertainment pieces or consumer products. Users can export their own critique results of entertainment pieces and consumer products to affiliates, partners, etc. registered with the present invention.

The present invention further includes a record creator for creating a User's demographic profile. A User's demographic profile can consist of gender, age, material preference, location, likes/dislikes, religious affiliation, political affiliation, education level, User's critique status, hobbies, etc.

Users may be represented by avatars. For example, Users can be represented by the mask of a Tiki (a large wooden carved figure). Avatars can be interactive and can be customized/personalized with various shapes, colors, sizes, etc.

Users may be represented or identified by status or User level. For example a User's status can be defined as (but not limited to) words such as: Rookie, Amateur, Novice, Pro, Guru, or levels such as Level 1, Level 2, etc. A User's status may change based upon the total number of critiques performed on entertainment pieces and consumer products. For example, a User who has critiqued 100 entertainment pieces may reach the “status or level” of Rookie; and a User who has critiqued 500 entertainment pieces may reach the “status or level” of Pro.

Users can receive “points” based upon the total number of entertainment pieces or consumer products the User's has critiqued. The number of points earned by a User can be exchanged for prizes, awards, gift certificates, monetary awards, electronic discount coupons, etc. These prizes, awards, gift certificates, monetary awards, electronic discount coupons, etc. will be given or awarded by manufacturers, studios, advertisers, entertainment venues, etc. For example, a User who has critiqued 100 movies can earn 100 points to use towards the purchase of movie tickets to a theater chain, or a one-month Netflix subscription, etc.

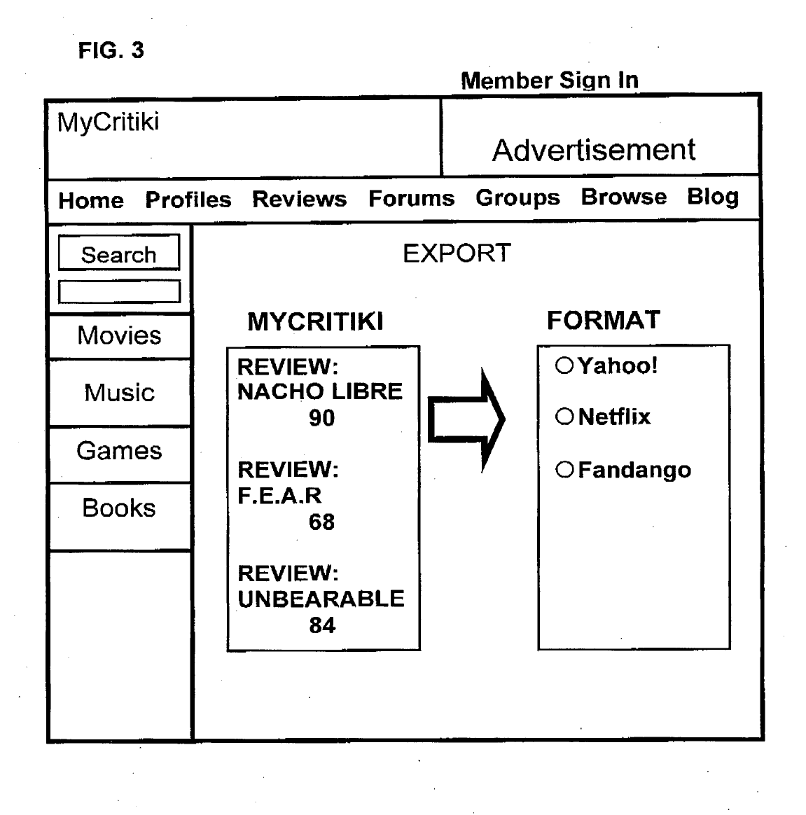

The critique results within the server database can be exported/ imported, merged to/with, interacted with, and or RSS fed to/with other databases such as LitCentral, Moviefone, Fandango, Netflix, Movie.com, Yahoo, Google, AOL, MSN, MySpace, LA Times, etc. (FIG. 3) either by a User or directly from the web application. For example, the present invention can establish a relationship with Netflix whereby all critique results are exported to Netflix on a daily basis. These exported critique results can be merged and attached to the corresponding Netflix entertainment piece to provide a more precise opinion or review of the entertainment piece.

The present invention receives revenue from advertisers, affiliates, partners, entertainment venues, etc., and or manufacturers wishing to advertise, affiliate, or use the present invention to receive consensus on a “product” via controlled focus groups.

The present invention can allow for on-line purchases to be implemented. Links to paid advertisers/affiliates websites, and or a specific product of the advertiser/affiliate, can be displayed on the web application of the present invention. With the present invention's demographic profiling, completed by each User upon registration, advertisers/affiliates can directly market to specific demographic groups. For example, an advertiser who is advertising golf attire, can specifically target Users who listed “golf” as a hobby or profession.

The present invention can contain message boards, discussion forums, and chat rooms for peer-to-peer communication regarding entertainment pieces or consumer products. Instant Messaging and other communication protocols may be implemented for providing communication between Users. For example, Users can join message boards, chat rooms, etc., and use Instant Messaging to communicate with other Users within the same message board/chat room.

Currently entertainment pieces and consumer products are critiqued (reviewed, assessed, analyzed) by either paid critics or the general public to determine the quality or value of the entertainment piece or consumer product. A typical current process used in critiquing an entertainment piece or consumer product is similar, but not limited, to: a) viewing the entertainment piece or consumer product, b) giving an opinion by either completing a survey, or selecting a grade of poor/fair/good, thumbs-up/thumbs-down, 1-4 stars, etc.

There is currently no universal grading system that accurately, objectively and/or categorically quantifies a person's opinion of an entertainment piece or consumer product; it is based solely upon a person's interpretation/opinion. Poor/fair/good, thumbs-up/thumbs-down, 1-4 stars, etc. is an ambiguously flawed grading system because it assumes each person's “poor” or “fair” or “good” is based on the same set of criteria. Inherently, each person has his or her own ideology of “poor,” “fair,” and “good,” and thus a quantified analysis using such can be as inconsistent as each person's personal standards. For example, one person's interpretation when critiquing a movie and giving a grade of “3 stars” may mean “the movie was enjoyable, but hard to follow” and another person's interpretation and grade of “3 stars” may mean, “the movie was okay, but I would not recommend it to another”.

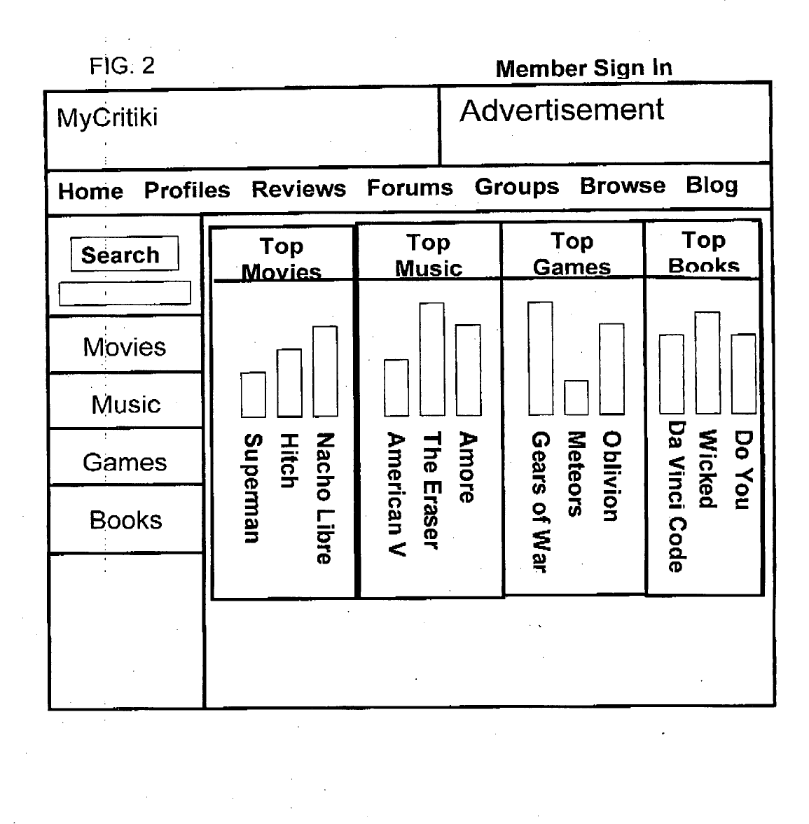

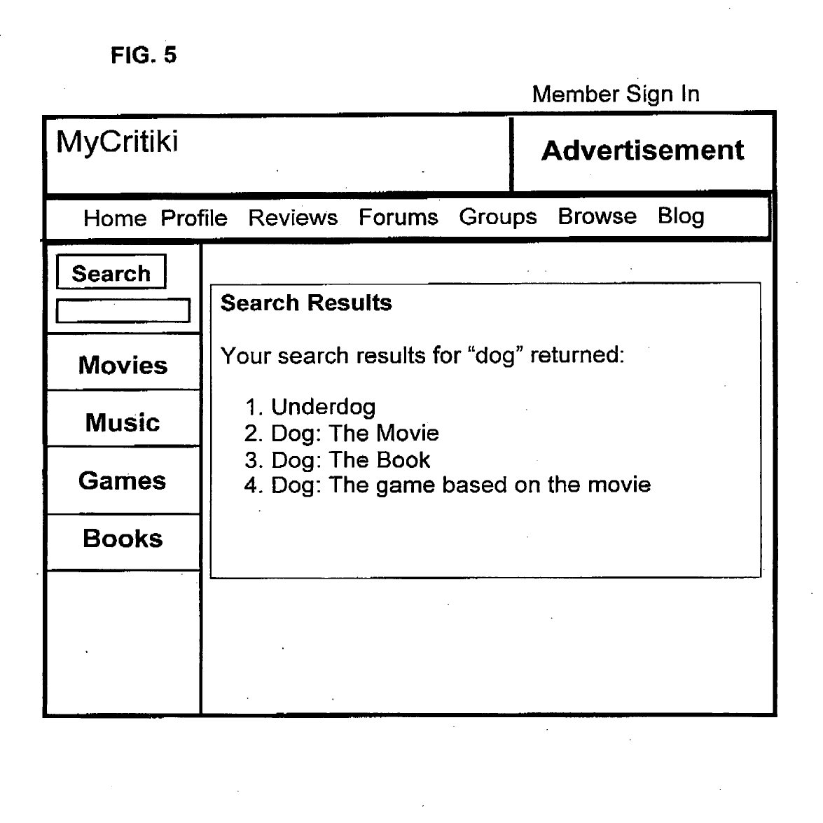

The web application database of the present invention can be accessed by both the general public (individuals) as well as registered Users (Members). The general public may only view or search critique review scores of a specific entertainment piece and or consumer product. To access the web application database, an individual within the general public would insert the present invention's URL into their browser bar. The web application's Home Page (FIG. 2) is an overview of the critique results for the most popular entertainment pieces which have been critiqued by registered Users. The general public may also search for a specific entertainment piece by inserting the title of the entertainment piece into the SEARCH area on the Home Page. Search results will be displayed (FIG. 5).

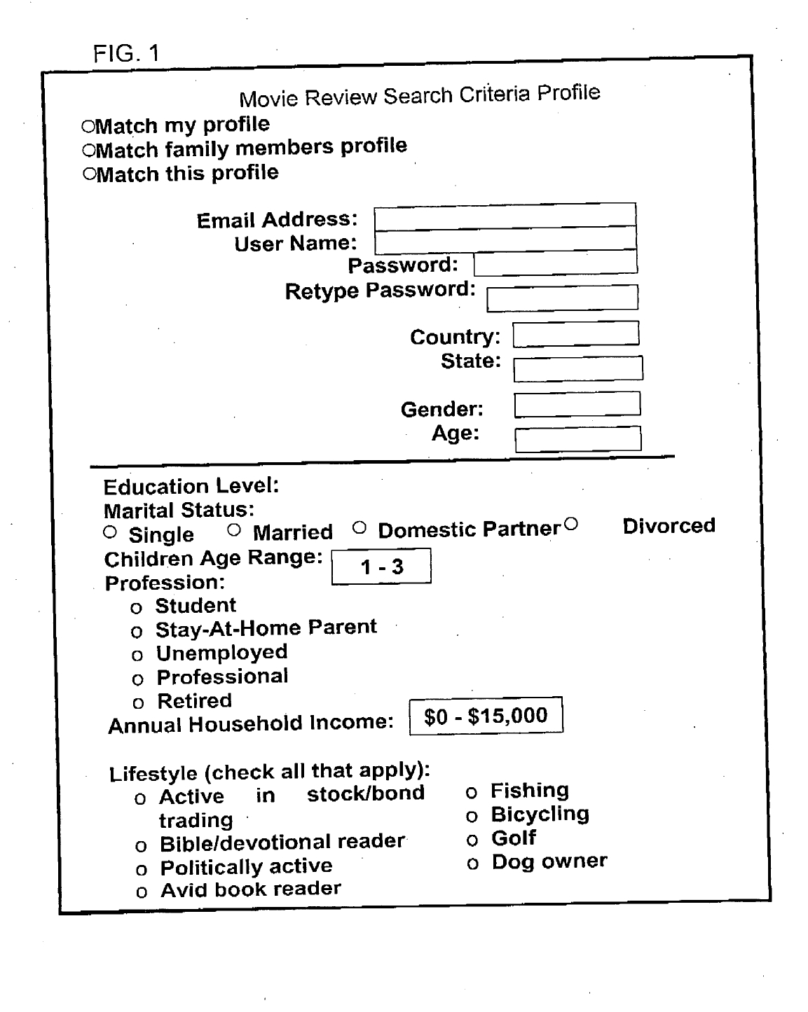

Users can not only view or search for the critique review scores of a specific entertainment piece and or consumer product, but can also critique (assess, review, analyze) an entertainment piece and or consumer product. User's can also search critique results by a specific demographic, or another User's critique status/level. Registered Users can also access message boards, chat rooms, and forums and communicate with other Users using Instant Messaging. User's have the ability to create several demographic profiles (in addition to their personal demographic profile) for their children, significant other, etc. (FIG. 1). User's can export their critique results to affiliates, partners, etc. (FIG. 3)

To become a User of the present invention, one must register for the web application database service. To register, a User provides personal contact information, creates a User-id and password (consisting of alpha/numeric characters), and generates an expanded demographic profile (FIG. 1). A demographic profile consists of various information such as: country, state, gender, age, # in household, education level, marital status, profession, lifestyle, hobbies, etc. A User can edit their demographic profile at any time by clicking on the Profiles tab on the Home Page of the web application database. Users may create additional demographic profiles, in addition to their required personal profile, to be used for their children, significant other, etc. Demographic profiling is a way for Users to search for specific critique review scores of an entertainment piece, based upon specific criteria. For example, a User who is a 35-year old, college educated female, wanting to see the latest “chick flick”, could search for the critique review scores of the newest movie releases based on the following criteria: female, age 30-40, college educated. This would produce the critique review scores of a specific entertainment piece, for a demographic profile that closely matches the User. Demographic profiling is also a way for advertisers, affiliates, and partners to target a specific type of User by matching products to a specific demographic profile. For example, studios wanting to advertise the latest movie release of Scream 3, could include trailers or advertisements for that specific movie on the Home Page for Users who fit a profile of say: male/female, age 18-24.

Referring more particularly to the drawings, FIG. 2 illustrates the Home Page of the invention. The Home Page contains the critique review results and corresponding bar graph of the “top” or “most popular” entertainment pieces which have been critiqued by Users. The Home Page is where a User (or the general public) can search for a specific entertainment piece, by inserting the title of the entertainment piece into the SEARCH area (FIG. 5). The Home Page also allows for advertiser/affiliate advertising, movie trailers, etc.

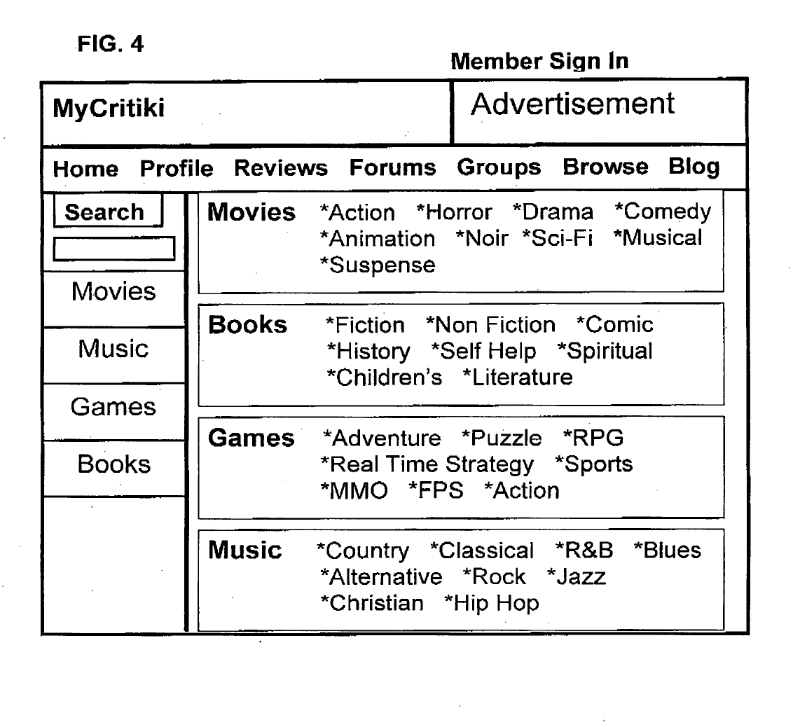

FIG. 4 displays the expanded search feature within the SEARCH area (registered Users have additional expanded search features as described below). By clicking on Expanded Search, a User or the general public is presented with genres associated with various entertainment pieces. Clicking on the genre within a specific entertainment piece category will display the top 20 entertainment pieces for the category, along with their critique review score. A User can receive a more detailed description of the entertainment piece by clicking on a specific entertainment piece within the top 20 list. For example, a person wanting to see the latest review results for the top 20 fiction books, would click on Fiction within the Books category. A list of the top 20 will be displayed. To receive a brief description of a specific entertainment piece within the list, the User would click on the specific entertainment piece and a brief description would be displayed. For example, the selected fiction book can appear as:
The Bean Trees
By: Barbara Kingsolver
Rating: 92

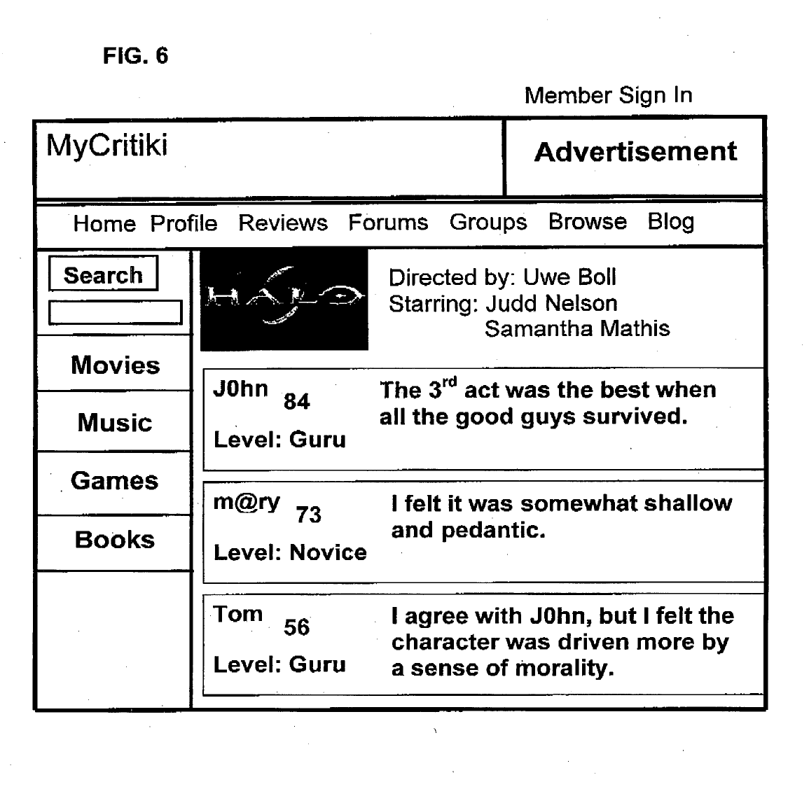

Users of the present invention have additional expanded search features such as but not limited to searching by: a specific numeric value (i.e. all entertainment pieces receiving a critique review score between 70-80, 80-90, etc.), a User's personal demographic profile, a specific demographic profile, or a combination of one or more of the above. The results will be displayed in list format with the title of the entertainment piece, type of entertainment piece, and numeric value for the entertainment piece. For example, if a User would like the critique review results of any entertainment piece that has a numeric value between 90-100, they could input that information in the corresponding field within the expanded search feature, and a list of the corresponding entertainment pieces will be created. Once the results have been displayed, the User can click on a specific entertainment piece within the list, to display additional information and the latest three comments from Users who have critiqued that specific entertainment piece (FIG. 6). For example, FIG. 6 displays the title, director and actors associated with the movie Halo: The Movie and comments and numeric values from the last three User's who critiqued this movie.

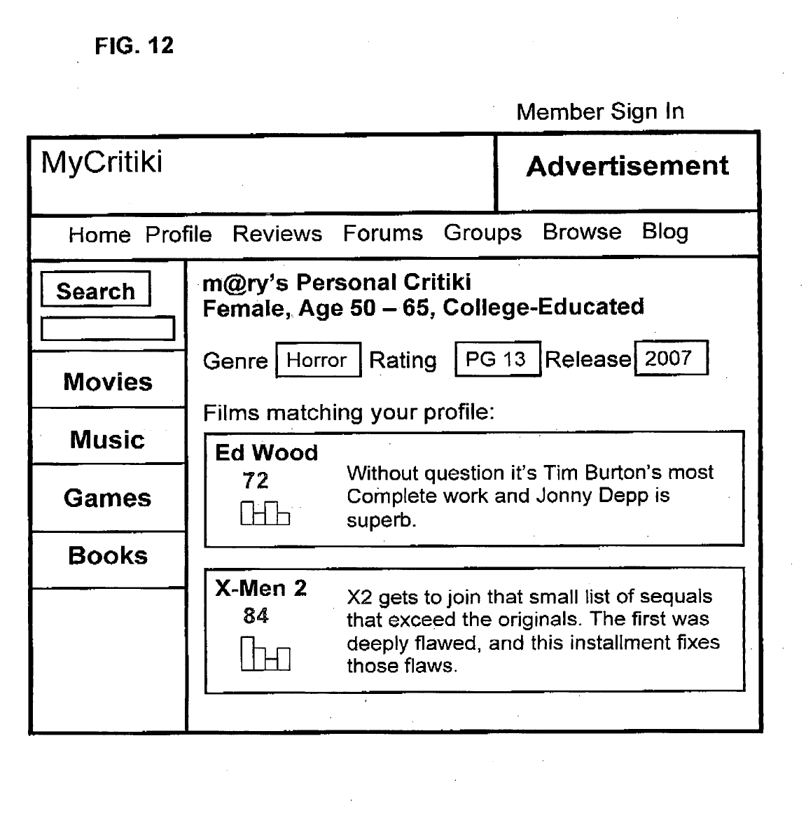

FIG. 12 illustrates the results of a User's expanded search for various criteria associated with entertainment pieces. For example, if a User is searching for an entertainment piece within their demographic profile, containing the criteria of a specific genre, rating, or release date, the User would input the desired information would in the corresponding expanded search fields. Entertainment pieces matching this criteria would be displayed three entertainment pieces at a time.

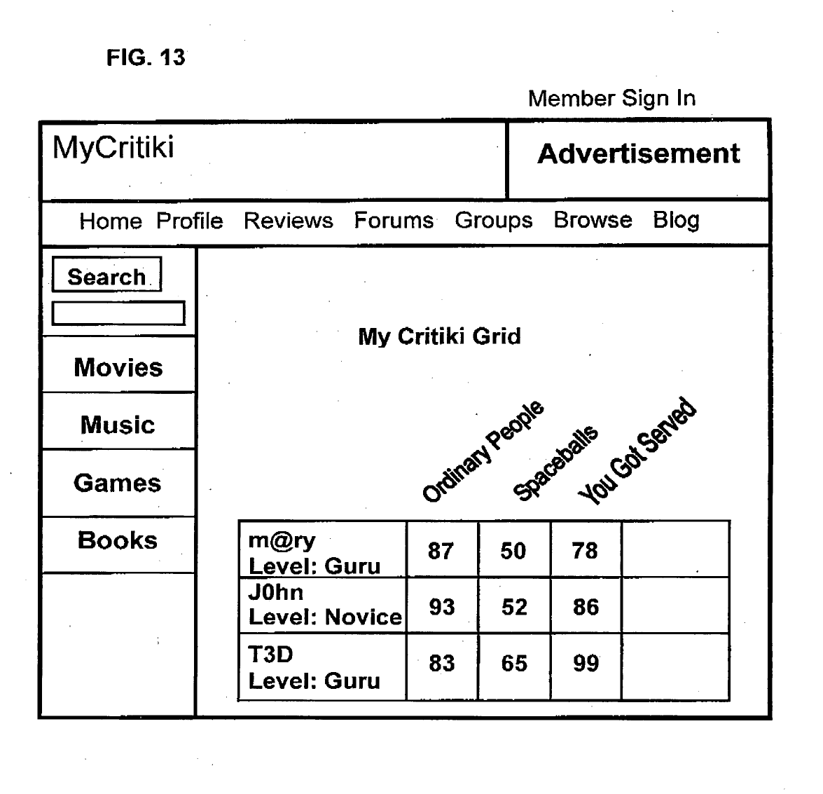

FIG. 13 illustrates a grid of multiple entertainment pieces and the critique review scores of specified Users. For example, if a User wants to compare their critique review score on 3 different movies, with the critique review scores of 2 of their friends (who are also Users), they can do so by clicking on Reviews (on the Home Page), Grid and thereby inputting the titles of the entertainment pieces and User id's of their friends.

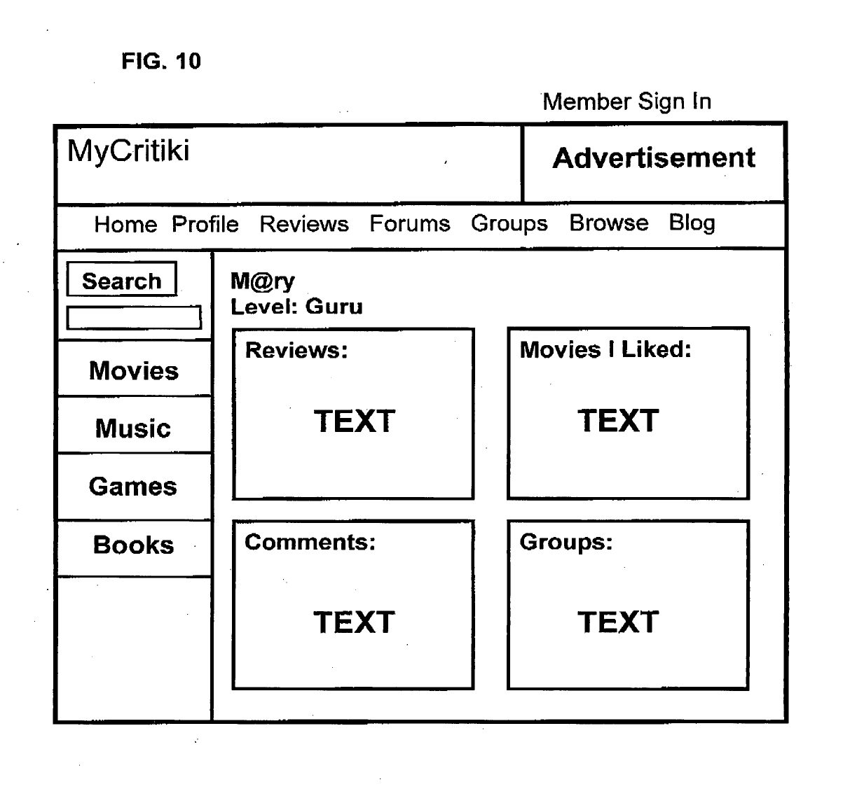

FIG. 10 illustrates a User's customized Home Page of the web application. This page can be customized to list various sections of the web-application such as: my latest reviews, message boards/forums, favorite movies, favorite Users, Instant Messaging, etc. This allows a User to customize a Home Page in a manner that is friendly to the User.

The present invention uses a methodology of assessment called a Rubric—a cumulative scoring guide used in the assessment of an entertainment piece or consumer product. A Rubric produces a mathematical sum based on a full range of specific criteria. Mathematical sums produce numeric values thereby allowing for quantification based on identifiable and relatively objective criteria. Because the Rubrics set forth specific criteria, define precise requirements for meeting those criteria, and assign numerical scores to each level of performance, they provide an effective, objective method for evaluating entertainment pieces or consumer products that do not generally lend themselves to objective assessment methods. The Rubrics also provide a set of standards and expectations for evaluating an entertainment piece or consumer product.

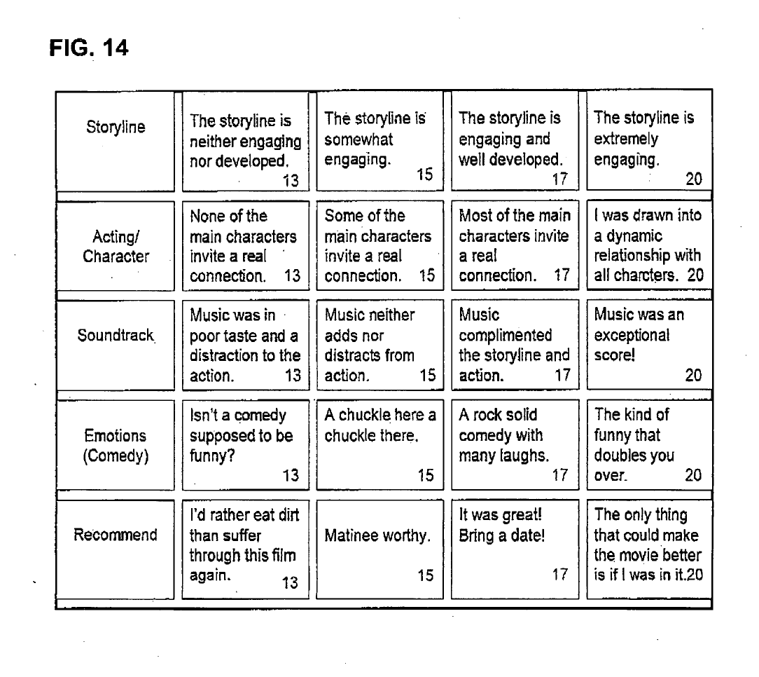

The Rubric of the present invention contains a set of elements which define and describe what the inventors ascribe to be the important components of an entertainment piece or consumer product and provide a User (e.g., one who critiques) a set of clearly defined criteria on which to express his or her interpretation/feedback on an entertainment piece or consumer product. As presently embodied, each element of the Rubric is followed by one of five weighted declarative statements (cf. FIG. 14). Each declarative statement is based on a gradation, with a score of 10-20 assigned to each statement, and a clear description of the criteria needed to attain the score at each level. By breaking down the elements of an entertainment piece or consumer product, defining a specific set of criteria (e.g., declarative statements), and attaching weighted values to such criteria, Users will have a guideline for critiquing and analyzing the value of an entertainment piece or consumer product. While Rubrics still allow for some subjectivity, their relative consistency surpass typical, relatively ambiguous methods used today of poor/fair/good, thumbs-up/thumbs-down, 1-4 stars, etc. The beginning part of a Rubric, according to an exemplary implementation, is provided below in grid format:

| | 10 | 13 | 16 | 17 | 20 |
|---|---|---|---|---|---|
| Storyline | The storyline is | The storyline is | The storyline is both | The storyline is highly | The viewer is engaged in |
| | neither engaging nor well | somewhat engaging but | engaging and original. | engaging and extremely | an extremely original |
| | developed. There are no | not original. However, | There are occasional | original. There are | storyline from the moment |
| | surprises or twists. | there are no surprises | surprises or twists. | several surprises or | the film begins. Numerous |
| | | or twists. | | twists. | surprises and twists keep |
| | | | | | the viewer breathless. |
| Acting/ | None of the main | Some of the main | Most of the main | All of the main characters | Viewers are drawn into a |
| Character | characters invite a real | characters invite a | characters invite a | invite a real connection; | dynamic relationship with |
| Development | connection; the acting | real connection; and | real connection, acting | the acting is natural | all characters; the |
| | comes off as | the acting is less | approaches believable. | and believable. | acting was flawless. |
| | “artificial”. | artificial. | | | |
| Soundtrack | Music was actually a | The music was boring; | The music complemented | The music expressed the | The music was to this |
| | distraction to the | did neither add nor | both the storyline and | unspoken dialogue. | movie what the musical |
| | action; like coyotes | distract, almost | action on the screen. | | score is to a beautifully |
| | howling in the wild. | unnecessary. | | | choreographed ballet. |
| Emotions | Isn't a “comedy” | If you've seen the | A chuckle here, a | LOL! | The kind of funny that |
| (Comedy) | supposed to be funny? | trailer, you've seen | chuckle there . . . | A rock solid comedy. | doubles you over, and |
| | | the comedy. | | | knocks you out of your |
| | | | | | chair. |
| My | I would rather eat dirt | Better than watching | Matinee worthy. | It was great, bring a | The only thing that could |
| Recommen- | than suffer through this | paint dry. | | date, and don't be late! | make this movie better is |
| dation | film again. | | | | if I starred in it myself. |

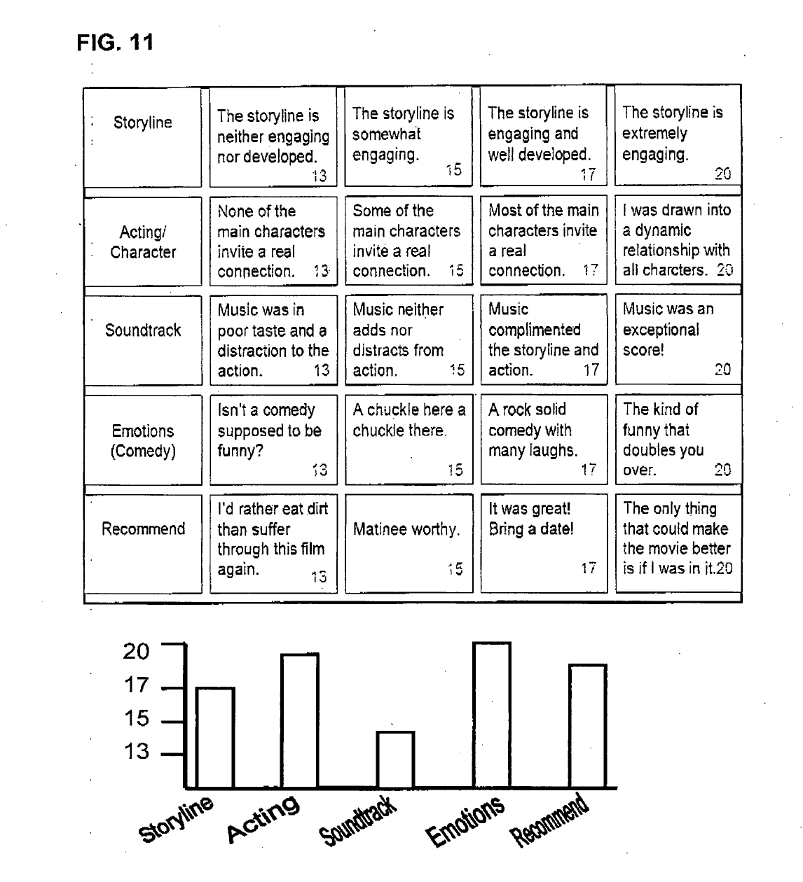

FIG. 14 (and FIG. 11 displays the Rubric associated with a movie, specifically a comedy. Elements for this specific Rubric are: Storyline, Acting/Character Development, Soundtrack, Emotions, My Recommendation. A Rubric—with elements and declarative statements—will be customized for all types of entertainment pieces and consumer products.

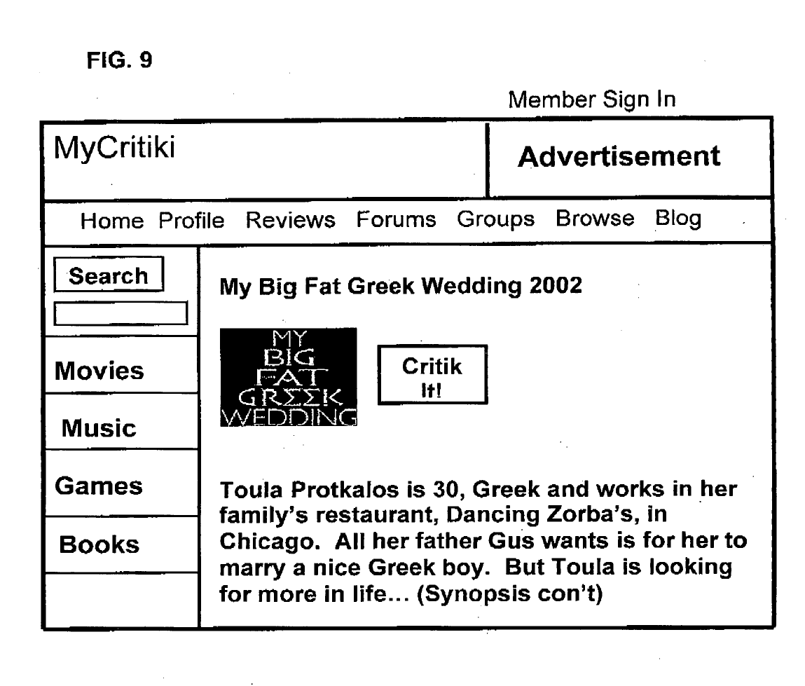

A User can critique an entertainment piece by searching for a specific entertainment piece (a brief description will be displayed) and clicking CRITIK IT (FIG. 9). This will transport the User to the Rubric within the present invention.

FIG. 11 illustrates the Rubric and activates the grading mechanism, in grid format, which also produces a corresponding graph and numeric value. The grading mechanism is based on five elements, with each element being followed by five declarative statements pertaining to the element. The User chooses one of five declarative statements or responses to each element. Each declarative statement corresponds to a weighted numeric value anywhere from 10 to 20. Each weighted declarative statement is placed within a square shape and has a numeric value attached. The numeric values point system increment rankings are 10, 13, 15, 17, 20—with 10 giving the lowest score and 20 giving the highest score (these values can change or vary). When a User hovers the mouse/digitizer over the answer, the square will highlight to a correlating pale shade of color. When a User selects the answer using a mouse or digitizer, the square will change to a correlating darker shade of the above color. A User may also create a comment on an entertainment piece or consumer product they have critiqued. A comment box is provided at the end of the Rubric for a User to input their feedback or comments.

The Rubric for the present invention also produces a multi-colored graph. The graph consists of the same elements as the Rubric. As elements within the Rubric are ranked, the corresponding element within the bar graph will mirror that numeric score. The graph is a visual interpretation of the Rubric and gives a User a birds-eye view of the overall strengths and weaknesses of the entertainment piece or consumer product (based on the scoring of the Rubric). For example, when critiquing the movie “My Big Fat Greek Wedding, a User would select a declarative statement (based on their interpretation of the movie) for each of the five elements. As each declarative statement is selected, a numeric value is being calculated. Once the Rubric has been completed in its entirety, the final critique review score has been calculated and a corresponding graph will be produced. The graph depicts the results of the Rubric in bar/line/pie graph format.

Results from all critiques, from all Users within the web-application database are averaged to create a overall critique review score for an entertainment piece or consumer product. For example if 100 Users critiqued a movie, the average of these critique scores becomes the displayed critique score associated with the entertainment piece. Therefore, the critique review scores of an entertainment piece or consumer product are constantly fluctuating.

In view of the foregoing, it will be understood by those skilled in the art that the methods of the present invention can facilitate formation of workflow management systems and asset development. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. As iterated above, any feature or combination of features described and referenced herein are included within the scope of the present invention provided that the features included in any such combination are not mutually inconsistent as will be apparent from the context, this specification, and the knowledge of one of ordinary skill in the art. For example, any of the components, and any particulars or features thereof, or other features, including method steps and techniques, may be used with any other structure and process described or referenced herein, in whole or in part, in any combination or permutation. Accordingly, the present invention is not intended to be limited by the disclosed embodiments, but is to be defined by reference to the appended claims.

1. A web application for public use and market sample groups, the web application including a record creator for generating user demographic profiles, and allowing users to critique entertainment pieces by way of Rubrics, each Rubric relating to a given entertainment piece and presenting grading elements to a user pertaining to the entertainment piece wherein each element presents a choice of one or more statements to grade against, the completed Rubrics producing numeric scores that are attached to entertainment pieces along with user demographics from the profiles for quantification of the entertainment pieces' overall value based upon selectable demographic parameters.
